(19) United States
(12) Patent Application Publication
(10) Pub. No.: US 2025/0200365 A1
(43) Pub. Date: Jun. 19, 2025

(54) TRAINING A TENSORIZED OPTICAL NEURAL NETWORK (TONN) AS A PARTIAL DIFFERENTIAL EQUATION (PDE) SOLVER

(71) Applicants: The Regents of the University of California, Oakland, CA (US); HEWLETT PACKARD ENTERPRISE DEVELOPMENT LP, Spring, TX (US)

(72) Inventors: Zheng Zhang, Goleta, CA (US); Yequan Zhao, Oakland, CA (US); Xinling Yu, Goleta, CA (US); Xian Xiao, Spring, TX (US)

(21) Appl. No.: 18/980,125

(22) Filed: Dec. 13, 2024

Related U.S. Application Data
(60) Provisional application No. 63/610,985, filed on Dec. 15, 2023.

(51) Int. Cl. G06N 3/08; G06N 3/0495; G06N 3/067

(52) U.S. Cl. CPC G06N 3/08; G06N 3/0495; G06N 3/0675

(57) ABSTRACT

A system for back-propagation free training of a tensor-compressed optical neural network (TONN) of a TONN inference accelerator. The system performs an iterative training process. In a given iteration of the process, a model input generator generates encode input data and encoded parameters, and the TONN inference accelerator is forward evaluated based on the input data and parameters. A loss evaluator receives an output of the TONN inference accelerator and evaluates the loss of the TONN based on the received output. A zeroth-order optimizer estimates a gradient of the loss. Then, in a next iteration of the iterative training process, the encoded parameters are updated based on the gradient of the loss as estimated in the previous iteration.

### RELATED APPLICATIONS

This application claims priority to and the benefit of U.S. Provisional Application No. 63/610,985, filed Dec. 15, 2023, which is incorporated by reference herein in its entirety.

### STATEMENT OF GOVERNMENT SUPPORT

This invention was made with government support under Grant Nos. 1846476 and 2235414, awarded by the National Science Foundation. The Government has certain rights in the invention.

### INTRODUCTION

Photonic chips are a type of microchip that uses photons (light) instead of electrons to process information. They are made from materials that can manipulate light and are designed to perform specific functions, such as filtering, splitting, and modulating light signals. Photonic chips offer several advantages over traditional electronic chips, including faster processing speeds, lower power consumption, and higher bandwidth. They are particularly useful for applications that require high-speed data transfer and processing, such as telecommunications, data centers, and medical imaging.

Physics-informed neural networks (PINNs) are a type of machine learning algorithm that combines the power of deep neural networks with the physical laws that govern a system. PINNs can be used for a wide range of applications, including the solution of partial differential equations (PDEs) in fields such as fluid dynamics, electromagnetism, safety-critical autonomous systems, computational tomography, material design, and quantum mechanics. By incorporating known physical constraints into the neural network architecture, PINNs can learn to accurately predict the behavior of complex systems while also providing insights into the underlying physical processes.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 is a block diagram illustrating an example back-propagation-free optical PINN training accelerator system comprising a digital control system and a tensorized optical neural network (TONN) inference accelerator.

FIG. 2 is a schematic diagram illustrating an example tensor-compressed optical inference accelerator based on a TONN architecture with wavelength and space multiplexing, which is one example of the TONN inference accelerator of the optical PINN training accelerator system of FIG. 1.

FIG. 3 is a schematic diagram illustrating an example photonic tensor core architecture based on a Mach-Zehnder interferometer (MZI) mesh, which may be used in various examples of the TONN inference accelerators of FIGS. 1 and 2.

FIG. 4 is a schematic diagram illustrating an example photonic tensor core architecture based on a non-volatile memristive microring resonator (mem-MRR) crossbar array, which may be used in various examples of the TONN inference accelerators of FIGS. 1 and 2.

FIG. 5 is a process flow chart illustrating an example process for training optical PINNs for generic partial differential equations (PDEs).

### DETAILED DESCRIPTION

Partial differential equations (PDEs) are mathematical equations that help describe how a system changes over time and space. They have a wide range of applications in science and engineering, including (but not limited to) fluid flow, heat transfer, chemical reactions, and electromagnetic waves. Scientists and researchers can use PDEs as an effective tool to predict the behavior of complex systems. PDEs can be used in a variety of applications to simulate how a system may behave under different conditions, test different designs and hypotheses, and optimize performance. By solving PDEs, researchers can gain a deeper understanding of the fundamental laws that govern a system and develop new insights into the physical processes that underlie it. Effectively, PDE enables researchers to develop more efficient and effective technologies that can be used in a variety of scientific fields.

Solving PDEs is difficult because they are often highly complex, nonlinear equations. Traditional numerical methods for solving PDEs can be computationally intensive and require vast amounts of memory and computing time. Additionally, solving PDEs with high dimensions via conventional discretization-based methods (such as finite element or finite difference) suffer from the curse of dimensionality: the discretized equation size and number of unknown variables increases exponentially as a function of the PDE dimensionality. The computation becomes more challenging when solving a PDE-governed inverse problem or optimization problem, where a PDE needs to be solved repeatedly in every step of the inverse estimation or optimization framework.

In recent years, physics-informed neural networks (PINN) have become a relatively new approach to solving PDEs. PINN refers to a type of universal function approximator that can embed the knowledge of physical laws that govern a given data set in the learning process. PINN is capable of combining the power of neural networks with the physical laws that govern a system, allowing for more accurate and efficient solutions than traditional methods. PINNs can be particularly useful in applications where data is scarce or expensive to obtain, such as in experimental studies or simulations of complex systems. By incorporating physical constraints and information into the neural network architecture, PINN can learn to solve high-dimensional or parametric PDEs with zero or limited data and faster convergence than other numerical methods.

While PINNs offer a promising approach to solving PDEs, they also present some challenges. One difficulty is in training the neural network to accurately incorporate the physical laws that govern the system being studied. This requires a deep understanding of the underlying physics and the ability to translate that knowledge into a neural network architecture. Additionally, the convergence of PINNs can be sensitive to the choice of hyperparameters and can require significant computational resources to achieve accurate results. The long hours of training and the computation-intensive nature of PINNs can limit their applications in many resource-constraint and real-time scenarios.

To address these and other issues, disclosed herein are techniques for the training of optical neural networks (ONNs) as PDE solvers without back-propagation (BP). The training may be performed using example ONN training accelerator systems disclosed herein, which are specifically built to enable the training of an ONN. In some examples, the ONN which is trained is an optical PINN. In various examples, optical PINNs are trained using only additional inferences. In various examples, the ONN can be fabricated on photonic chips that utilize a tensor-compressed structure to improve the convergence of training, referred to herein as a tensorized optical neural network (TONN) inference accelerator. In various examples, the TONN inference accelerator leverages ultra-low-power wavelength-parallel photonic tensor cores as optical weight matrices to reduce requirements on hardware resources while maintaining nearly the same levels of optical computing performance. The photonic tensor cores may use an MZI mesh architecture in some examples or a mem-MRR crossbar array architecture in other examples.

Systems and methods in accordance with several examples disclosed herein have demonstrated their ability to successfully train neural networks to solve PDEs on photonic chips that require significantly lower system resources.

Turning now to the Figures, examples of the above-described ONN training techniques and systems configured to carry it out will be described in greater detail.

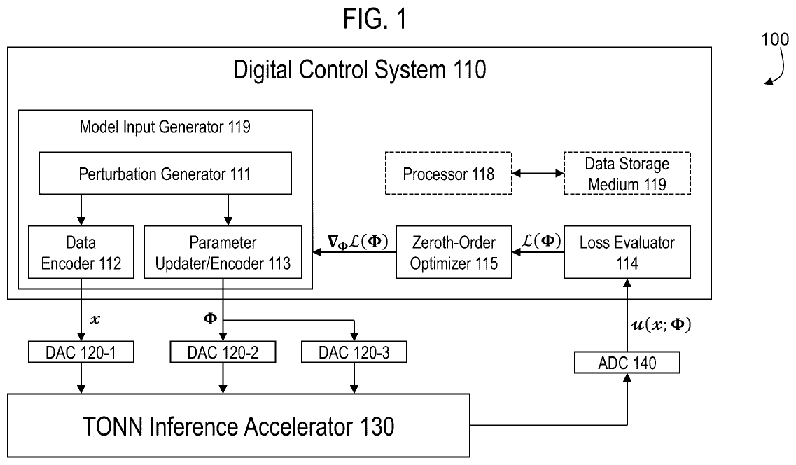

FIG. 1 illustrates an example ONN training accelerator system 100 (“system 100”). The system 100 includes a digital control system 110, digital-to-analog converters (DACs) 120 (including DAC 120-1, DAC 120-2, and DAC 120-3), a TONN inference accelerator 130, and an analog-to-digital converter (ADC) 140. The TONN inference accelerator 130 includes a TONN and the digital control system 110 can be used to train this TONN, for example to become a PDE solver.

In general, the system 100 trains the model by causing the digital control system 110 to provide input data x and model parameters Φ (in a tensor-train format) to the TONN inference accelerator 130, performing forward evaluation using the TONN inference accelerator 130 based on the input data x and model parameters Φ, providing the outputs [symbol] (x; Φ) of the TONN inference accelerator 130 back to the digital control system 110, and using the digital control system 100 to compute losses and update model parameters of the model being trained based on the outputs [symbol] (x; Φ). This process is then iteratively repeated, with new input data x and model parameters Φ based on the updated model parameters, until convergence conditions are met, whereupon the model may be deemed trained. The TONN which is being trained may include a PINN, a convolutional neural network (CNN), or any other model which can be represented as a TONN. TONN inference accelerator 130 may be fabricated on photonic chips, where weights of the model being trained can be implemented on the photonic chips as tensor-train decomposed optical weight matrices.

Digital control system 110 includes a model input generator 119 comprising a perturbation generator 111, a data encoder 112, and a parameter updater/encoder 113. The system 110 also comprises a loss evaluator 114, and a zeroth-order optimizer 115. Model input generator 119 generates a set of encoded input data x and encoded parameters Φ for input into the TONN inference accelerator 130. Specifically, perturbation generator 111 may provide perturbation parameters and can adjust input data x and model parameters Φ based on information received from the other components to generate updated model parameters that may be used in further iterations of training. Data encoder 112 encodes input data x and outputs the result to the DAC 120-1. Parameter updater/encoder 113 encodes the parameters Φ received from the perturbation generator 111 and outputs the result to the DACs 120-2 and 120-3. Loss evaluator 114 evaluates the losses of models that are trained by the system based on the output [symbol] (x; Φ) from TONN inference accelerator 130. Zeroth-order optimizer 114 estimates gradients of loss based on losses evaluated by loss evaluator 114. In selected examples, the estimated gradients of loss can then be fed to the model input generator 119 and used to generate updates to model parameters Φ such as low-rank tensor factors. Examples of these components of the system 100 will be described in greater detail in turn below.

Perturbation generator 111 generates the input data x and the parameters Φ. In particular, perturbation generator 111 provides perturbation to model parameters in a low-rank tensor format. In the context of model training, perturbation generator 111 can manipulate input data and tensor-train factors in a controlled manner to improve the model's stability and generalizability. In several examples, perturbation generator 111 can adjust model parameters such as input data and tensor-train factors to generate updated model parameters that may be used in further iterations of training.

Data encoder 112 encodes input data x received from the perturbation generator 111, with the encoded input data being output to the DAC 120-1. The DAC 120-1 then converts the input data x to an analog form for TONN inference accelerator 130. Known data encoding methods such as feature scaling may be used to encode input data. In many examples, data encoder 112 converts the data into a digital representation of the drive voltages that will be used to drive the optical modulators at the corresponding input waveguides of the TONN, as will be described in more detail below. The DAC 120-1 then converts these digital representations into the actual analog drive voltages.

Parameter updater/encoder 113 encodes the parameters Φ received from the perturbation generator 111, with the encoded parameters Φ being output to the DACs 120-2 and 120-3. The DACs 120-2 and 120-3 then convert the encoded parameters Φ to an analog form for TONN inference accelerator 130. Parameter encoding methods may take into consideration the loss functions of the model. In several examples in which the TONN has photonic tensor cores using the MZI-mesh architecture, parameter updater/encoder 113 converts the parameters into a digital representation of the drive voltages of the phase shifters of the MZI elements in the photonic tensor cores. In several examples in which the TONN has photonic tensor cores using a mem-MRR-crossbar architecture, parameter updater/encoder 113 converts the parameters into a digital representation of the drive voltages of the mem-MRR elements in the photonic tensor cores. In both cases, the DAC 120-2 and 120-3 may convert these digital representations of the drive voltages into the actual analog drive voltages.

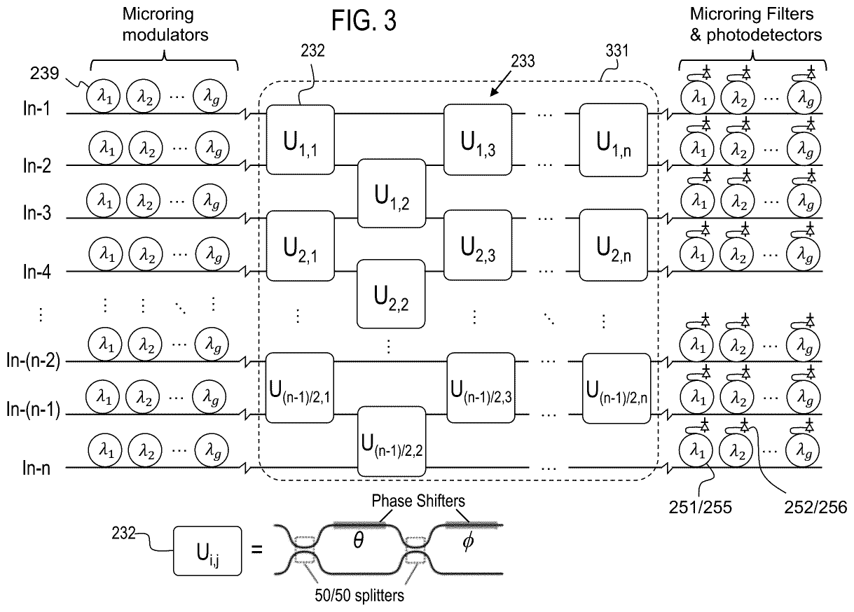

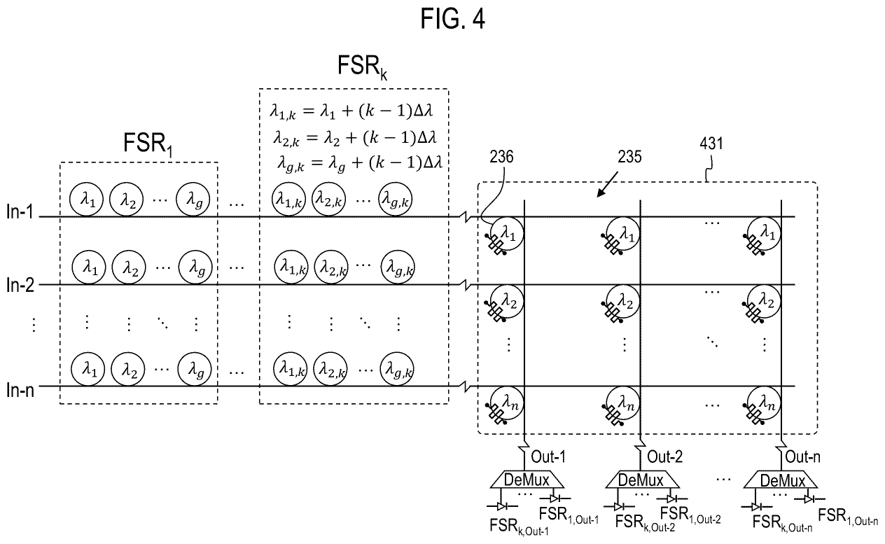

The parameters Φ comprise a set of tensor components from a tensor-train decomposition representing a weight matrix W of the neural network being molded by the TONN. More specifically, in some examples, the TONN architecture utilizes singular value decomposition (SVD) to implement matrix-vector multiplication (MVM), i.e., y= [symbol] x=UΣV*x. In such examples, the parametrization of U and V* is given by U(n)=DΠⱼ₌₁ⁱ⁻¹Rᵢⱼ(ϕᵢⱼ) where D is a diagonal matrix and each 2-dimensional rotator Πⱼ₌₁ⁱ⁻¹Rᵢⱼ(ϕᵢⱼ) can be implemented by a programmable optical element (or “neuron”) in the TONN which can shift a phase of received light according to a programmable phase shift parameter. Herein the programmable phases of the TONN elements are collectively denoted as the parameters Φ, and thus the weights W of the TONN are parametrized as [symbol] (Φ). In other words, the parameters Φ output by the parameter updater/encoder 113 cause the DACs 120-2 and 120-3 to supply drive voltages to the various optical elements and these drive voltage set the amount of phase shifting performed by the phase shifting components so as to cause the optical tensor cores of the TONN to embody the weights [symbol] (Φ). In some examples, the TONN has an MZI-mesh architecture, in which case each 2-dimensional rotator Πⱼ₌₁ⁱ⁻¹Rᵢⱼ(ϕᵢⱼ) can be implemented by a 2×2 MZI 232 containing two phase shifters and two 50/50 splitters, as shown in FIG. 3. In this case, the Notably, the parameters Φ control the states of at least some of these phase shifters to adjust a phase shift provided thereby. In other examples, the TONN architecture utilizes mem-MRR crossbar 235 comprising an array of mem-MRR elements 236, such as in the example illustrated in FIG. 4. In such examples each 2-dimensional rotator Πⱼ₌₁ⁱ⁻¹Rᵢⱼ(ϕᵢⱼ) can be implemented by an mem-MRR element 236 containing a microring resonator and a memristor, as shown in FIG. 4. The memristor cases a phase shift in light passing through the microring resonator according to a state of the memristor, which can be adjusted by applying different driving voltage thereto. Thus, in this case, the parameters Φ control the states of the memristors to adjust the phase shift provided thereby.

In various examples, to increase the scalability of the ONN, a tensorized optical neural network (TONN) is proposed to realize large-scale ONNs with reduced hardware resources (i.e., MZIs) using the tensor-train (TT) decomposition algorithm. Let Wϵ [symbol] be a generic weight matrix in a neural network. The dimension sizes of W may be factorized as M=Πᵢ₌₁^{L}mᵢ and N=Πⱼ₌₁^{L}nᵢ, then W may be folded into a 2L-way tensor [symbol] ϵ [symbol] , and then [symbol] may be parameterized with the TT decomposition:

$$W ( {i}_{1} , {i}_{2} , … , {i}_{L} , {j}_{1} , {j}_{2} , … , {j}_{L} ) = {\prod }_{k = 1}^{L} {G}_{k} ( {i}_{k} , {j}_{k} ) \qquad ( eq . 1 )$$

Here, Gₖ(iₖ, jₖ)ϵ [symbol] is the (iₖ,jₖ)^{th} slice of the TT-core Gₖϵ [symbol] by fixing its 2^{nd} index as iₖ and 3^{rd} index as jₖ. The vector (r₀, r₁, . . . , r_{L}) is called TT-ranks with the constraint r₀=r_{L}=1. This TT representation reduces the number of unknown variables from Πₖ₌₁^{L}mₖnₖ to Σₖ₌₁^{L}rₖ₋₁mₖnₖrₖ. In some examples, Φ comprises a set of tensor components resulting from this TT decomposition, which may include the factors on the right-side of equation 1. Note that equation 1 may represent one layer of the weights of the neural network, but multiple layers may be present and if so then Φ may include components from each layer. In some examples, when paramters Φ are input to the TONN, each tensor core of the TONN may receive driving signals which corresponding to one slice of the TT-core.

In various examples, loss evaluator 114 can evaluate the losses [symbol] (Φ) of the models that are trained by the system based on the output [symbol] (x; Φ) from TONN inference accelerator 130. In numerous examples, ONN training accelerator system 100 can be used to train PINNs to solve PDEs by encoding PDEs into the loss functions of PINNs, which allows for the incorporation of physical laws into neural networks. For example, in some implementations in which the model is being trained as a PDE solver, the losses [symbol] (Φ) may be given by:

$$ℒ ( Φ ) = {ℒ}_{r} ( Φ ) + {λℒ}_{0} ( Φ ) \qquad ( eq . 2 )$$

wherein [symbol] ᵣ(Φ) represents loss associated with the residual of the PDE and [symbol] ₀(Φ) represents loss associated with the initial (or terminal) condition of the PDE. The PDE may have the form:

$$[ u ( x , t ) ] = l ( x , t ) \qquad ( eq . 3 )$$

$$[ u ( x , 0 ) ] = g ( x )$$

wherein [symbol] is a general nonlinear differential operator, [symbol] represents the initial or terminal condition, and u(x; t) represents the solution of the PDE. In the context of the PINN being trained to solve this PDE, the neural network u (x; Φ) parameterized by Φ may be substituted into the PDE as u, resulting in a residual defined as:

$$r ( x , t ; Φ ) = 𝒩 [ u ( x ; Φ ) ] - l ( x , t ) \qquad ( eq . 5 )$$

In this context, the losses Lᵣ(Φ) and L₀(Φ) from equation 2 may be given by:

$${ℒ}_{r} ( Φ ) = \frac{1}{{N}_{r}} {\sum }_{i = 1}^{{N}_{r}} {‖ r ( {x}_{r}^{i} , {t}_{r}^{i} ; Φ ) ‖}_{2}^{2} and \qquad ( eq . 6 )$$

$${ℒ}_{0} ( Φ ) = \frac{1}{{N}_{0}} {\sum }_{i = 1}^{{N}_{0}} {‖ [ u ( {x}_{0}^{i} , 0 ; Φ ) - g ( {x}_{0}^{i} ) ] ‖}_{2}^{2}$$

The differential operator [symbol] in Equation (3) involves first-order and high-order derivatives of u with respect to x. It is hard to compute these derivatives via a back-propagation (BP) process on a photonic chip. Instead, in examples disclosed herein, a BP-free method may be used. A first suitable method is finite difference, which calculates the derivatives by perturbing each element of x. An alternative method uses sparse-grid Stein estimator. Both methods only require a few additional inferences with coordinate-wise perturbed input data to estimate first- and second-order derivatives, then compute [symbol] (Φ). The photonic elements of the TONN (e.g., MZIs or mem-MRRs) do not need to be re-programmed when estimating the derivatives.

Zeroth-order optimizer 115 can be used to estimate gradients of loss ∇_{Φ} [symbol] (Φ) based on the losses [symbol] (Φ) evaluated by the loss evaluator 114. In selected examples, the estimated gradients of loss ∇_{Φ} [symbol] (Φ) can be used to generate updates to model parameters such as low-rank tensor factors representing the weight matrices. In some examples, zeroth-order optimizer 115 uses a BP-free method to estimate ∇_{Φ} [symbol] (Φ). In some examples, this method comprises using a zeroth-order gradient estimator, and Simultaneous Perturbation Stochastic Approximation (SPSA) to obtain a randomized estimation of the gradient. Specifically, given a model parameterized by Φ and a loss function [symbol] (Φ), SPSA computes a randomized gradient estimation of:

$${\hat{∇}}_{Φ} ℒ ( Φ ) = {\sum }_{i = 1}^{N} \frac{1}{N μ} [ ℒ ( Φ + {μξ}_{i} ) - ℒ ( Φ ) ] {ξ}_{i} \qquad ( eq . 7 )$$

Here, {ξᵢϵ [symbol] }ᵢ₌₁^{N} are N i.i.d. samples drawn from N(0,I^{d}) and μ is the sampling radius. In addition, the zeroth-order optimizer 115 may de-noise the SPSA gradient estimation by preserving only the sign for each update. Specifically, in some examples, given a learning rate a, the PINN model parameters are updated as:

$${Φ}_{t} ← {Φ}_{t - 1} - α \cdot sign ( {\hat{∇}}_{Φ} ℒ ( Φ ) ) \qquad ( eq . 8 )$$

In other examples, rather than using just the sign of the gradient, the parameters may be updated based on the full gradient itself, i.e.: Φₜ←Φₜ₋₁−α\hat{∇}_{Φ} [symbol] (Φ).

Loss functions of the PINNs may be continuously estimated and evaluated with each iteration of PINN training. In several examples, systems and methods estimate the gradients of loss. The estimations may be used to generate updated model parameters for the PINNs, such that the PINNs can be continuously refined as a PDE solver. By utilizing tensor-decomposed optical weight matrices, systems and methods in accordance with many examples require much fewer resources and footprint.

Digital control system 100 may include electronic circuitry and logic which instantiates the components described above and which is configured to perform the various functions described in relation thereto. Logic, as used herein, refers to hardware, machine readable instructions executable by a processor, or the combination thereof which are configured to perform some specified functions. In some examples, the components of the digital control system 100 described above may be formed from one or more processors 118 (e.g., CPU, GPU, or any other processing circuitry) executing instructions stored in a non-transitory data storage medium 119 (such as a memory device, storage drive, etc.). In some examples, the components of the digital control system 100 described above may be formed from one or more dedicated hardware devices, such as ASICs, FPGAs, CPLDs, discrete logic circuits, etc. In some examples, the components of the digital control system 100 described above may be formed from a combination of dedicated hardware devices and one or more processors 118 executing stored instructions.

As previously noted, some or all of TONN inference accelerator 130—particularly the optical tensor cores thereof—may be formed on an optical or photonic chip. In some examples, TONN inference accelerator 130 and digital control system 110 may be integrated together as part of the same semiconductor package, such as a system-on-chip (SoC), multi-chip package, or any other form factor which combines the TONN inference accelerator 130 and digital control system 110 into the same module. In other examples, TONN inference accelerator 130 and digital control system 110 may be part of physically distinct modules or packages which are both included as part of the same larger physical system—for example, the digital control system 110 may be implemented via a processor 188 of a server which executes instructions stored in a medium 119 of the server, and the TONN inference accelerator 130 may be implemented as an accelerator module which is physically distinct from but communicably connected with the processor 118 (e.g., the accelerator module may be plugged into an expansion slot of a motherboard of the server). In still other examples, the TONN inference accelerator 130 and digital control system 110 may be part of physically remote systems. For example, the digital control system 100 may be part of a first server while the TONN inference accelerator 130 is part of a second server remote from the first server, with communications therebetween passing through an intermediate network or networks (which could include, for example, the internet).

Although a specific example of system architecture is illustrated in FIG. 1, any of a variety of system architectures can be utilized in training neural networks similar to those described herein as appropriate to the requirements of specific applications in accordance with examples of the disclosure.

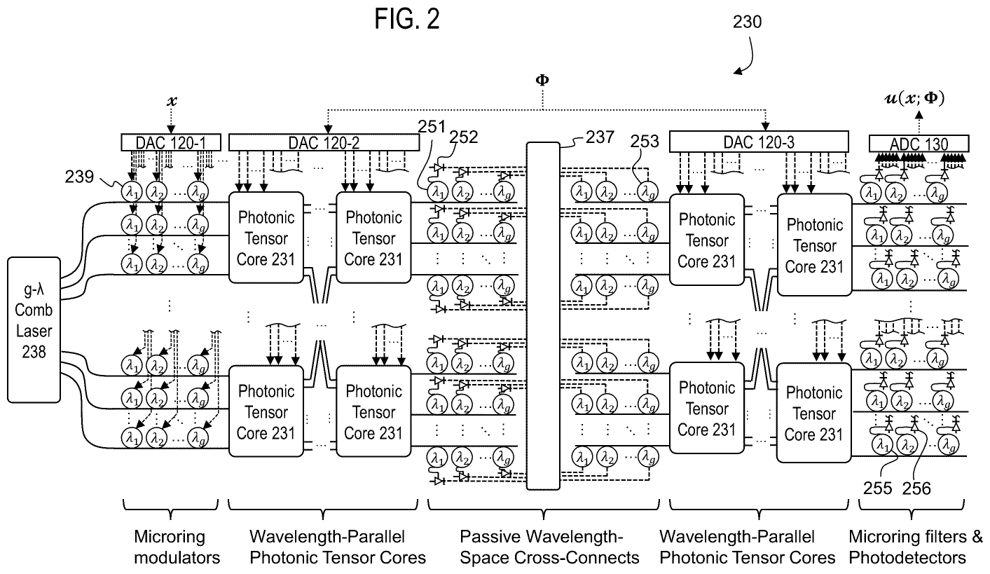

Turning now to FIG. 2, an example tensor-compressed optical inference accelerator based on a tensorized optical neural network (TONN) architecture, namely TONN inference accelerator 230, will be described. This TONN inference accelerator 230 is one example implementation of the TONN inference accelerator 130 of FIG. 1, but the TONN inference accelerator 130 is not limited only to TONN inference accelerator 230. In FIG. 2, light signals (or the interconnects carrying them) are indicated by solid lines, analog electrical signals (or the interconnects carrying them) are indicated by dashed lines, and digital electrical signals (or the interconnects carrying them) are indicated by dotted lines.

As shown in FIG. 2, TONN inference accelerator 230 includes a number of ultra-low-power wavelength-parallel photonic tensor cores 231. In FIG. 1, multiple such cores 231 are present, allowing for parallel operations and greatly reduced latency. In particular, in some examples, multiple photonic tensor cores 231 are cascaded in the space domain and parallelism is added in the wavelength domain such that the tensor multiplications between the input data and all tensor-train cores (the whole tensorized matrix) are realized in a single clock cycle. In other examples (not illustrated), a single instance of the photonic tensor core 231 may be utilized, in which case the passive cross-connects 237 (described below) may be omitted. In such an example, in each clock cycle, the photonic tensor core 231 with parallel processing in the wavelength domain is updated to multiply with the input tensor. Intermediate data may be stored in buffers for the next cycle. The example illustrated in FIG. 2 with multiple cascaded tensor cores 231 can allow for much reduced latency as compared to the single-core example, but the multi-core example has a larger footprint. The description below will focus on the multi-core example.

As shown in FIG. 2, TONN inference accelerator 230 may include a g-A comb laser 238, which may generate a baseband light stream having g discrete spectral components with different wavelengths denoted herein λ1, λ2, . . . , λg, g being any integer. The light stream is then duplicated via a power splitter (not illustrated) into n baseband light streams, each containing the g spectral components, and these baseband light streams are then fed to a first stage of tensor cores 231. Before entering the tensor cores 231, each light stream passes a string of g microring modulators 239 (only one is labeled). Each string of microring modulators 239 comprises g modulators 239, with each modulator 239 being configured to modulate a corresponding one of the wavelengths λ1, λ2, . . . , λg. These microring modulators 239 receive driving voltages from the DAC 120-1 discussed in relation to FIG. 1, which corresponding to the input data x, and this causes the microring modulators 239 to modulate the corresponding spectral components of the light stream based on the input data x. The modulated light stream is then fed into the photonic tensor core 231. Multiple such modulated input light streams, which have been modulated to reflect the input data x, can be input into each of the first-phase tensor cores 231, with each such light stream carrying the g modulated spectral components having the λ1, λ2, . . . , λg.

As mentioned previously, the encoded parameters Φ are input to the DACs 120-2 and 120-3, which convert these to analog electrical driving signals which are fed to the photonic tensor cores 231, thereby programming the photonic tensor cores 231 to collectively embody an optical weight matrix parameterized by Φ. Specifically, in some examples, each photonic tensor core 231 receives driving signals based on a corresponding subset of the parameters Φ. In some examples, each photonic tensor core 231 corresponds to a slice of the tensor train and receives driving signals associated with that slice. Once programmed by Φ, the first stage photonic tensor cores 231 may process the input light signals (e.g., shifting phases) and output intermediate light signals to additional downstream stages of photonic tensor cores 231 which in turn further process the light signals.

One or more collections of passive wavelength-space cross-connects 237 may be used to interconnect one or more groups of photonic tensor cores 231 with one or more other groups of photonic tensor cores 231. The cross-connects 237 may comprise microring filters 251 and photodetectors 252 to detect each spectral component of the light signals and convert them into an electrical signal, interconnect circuitry (not illustrated) to pass the electrical signals, and a series of microring modulators 254 that receive the electrical signals as drive voltages. Each microring modulator 254 is configured to modulate a corresponding wavelength of light based on the received electrical signal, thereby in effect converting these electrical signals back into light signals which are fed as inputs to the next stage of photonic tensor cores 231. The cross-connects 237 can enable signal regeneration and improve the cascadability without aggregating the optical loss.

After the light streams have exited the last stage of photonic tensor cores 231, they pass through another series of microring filters 255 and photodetectors 256 to convert the output light signals into output analog electrical signals which are supplied to the ADC 130. The ADC 130 then converts these analog electrical signals into digital electrical signals which represent the output [symbol] (x; Φ) of the TONN.

In the TONN inference accelerator 230, optical weight matrices can be realized in the photonic tensor cores 231, which are highly scalable such that the optical weight matrices can break the square scaling rule of conventional optical matrix-vector-multiplications (MVMs). In several examples, the photonic tensor cores 231 are built based on a non-volatile memristive microring resonator (mem-MRR) crossbar array. In numerous examples, TONN inference accelerator 230 is capable of photodetector-free hitless optical power monitoring. Hitless optical power monitoring can enable high-bit-accuracy MRR weight control based on a dithering scheme. In some examples, carrier waves used to transmit information for training are emitted from massively parallel dense wavelength division multiplexing (DWDM) comb laser sources. The DWDM comb laser sources may be fabricated as ultrahigh-speed optical transceivers.

Although a specific example of a TONN inference accelerator is illustrated in this figure, any of a variety of inference accelerators can be utilized in PINN training similar to those described herein as appropriate to the requirements of specific applications in accordance with examples of the disclosure.

Turning to FIG. 3, an example photonic tensor core 331 will be described. The photonic tensor core 331 is one implementation example of the photonic tensor cores 231 of FIG. 2. In this example, the photonic tensor core 331 uses the MZI-mesh architecture in which multiple MZI units 232 are arranged in an MZI mesh 233. Each MZI unit 232 may form a unitary optical matrix of the TONN, which may perform matrix functions on received light signals, such as matrix multiplication functions. Each MZI unit 232 may be formed as a 2×2 MZI which contains two phase shifters and two 50/50 splitters, and each MZI unit 232 may represent or implement a rotator Πⱼ₌₁ⁱ⁻¹Rᵢⱼ(ϕᵢⱼ) in the SVD of the TONN. As previously mentioned, the programmable phases of a TONN are collectively denoted herein as Φ, and in cases where the photonic tensor cores 331 are used in the TONN, the programmable phases of each of the MZI 232 thereof are included as components of Φ.

As shown in FIG. 3, modulated light streams may be fed as inputs into the photonic tensor core 331. The light streams may originate as the baseband light streams from the comb laser, with these streams being denoted In−1, . . . , In−n in FIG. 3, and these light streams be modulated by the string of microring modulators 239 as explained above. If the photonic tensor core 331 is in a first stage, it may receive the modulated light streams directly from the mirroring modulators 239. If the photonic tensor core 331 is in a downstream stage, then it may receive the modulated light streams from a previous upstream photonic tensor core 331 (either directly, or via a passive interconnect).

Within a given photonic tensor core 331, the MZI units 232 may be arranged in cascading stages. Pairs of the input light streams are input into each MZI unit 232 in a first stage, such as the input light streams In-1 and In-2 being input to the MZI unit 232 labeled U_{1,1}, the input light streams In-3 and In-4 being input to the MZI unit 232 labeled U_{2,1}, and so on. Subsequent stages of MZI units 232 receive as inputs the outputs from a previous stage. Specifically, the outputs of two prior stage MZI units 232 may be input into a single later stage MZI unit 232, such as the outputs of U_{1,1} and U_{2,1} being input to U_{1,2}, and so on as illustrated. Each MZI unit 232 may process the light signals received, such as by splitting, combining, and/or phase shifting the light signals. At least one of the phase shifters of each MZI unit 232 may be programmable based on the input parameters Φ. After exiting the last stage of MZI units 232, the processed light signals can be output to a subsequent stage of photonic tensor core 331 or to a series of microring filters 251/255 and photodetectors 252/253, depending on where the current core 331 is located in the TONN 130/230.

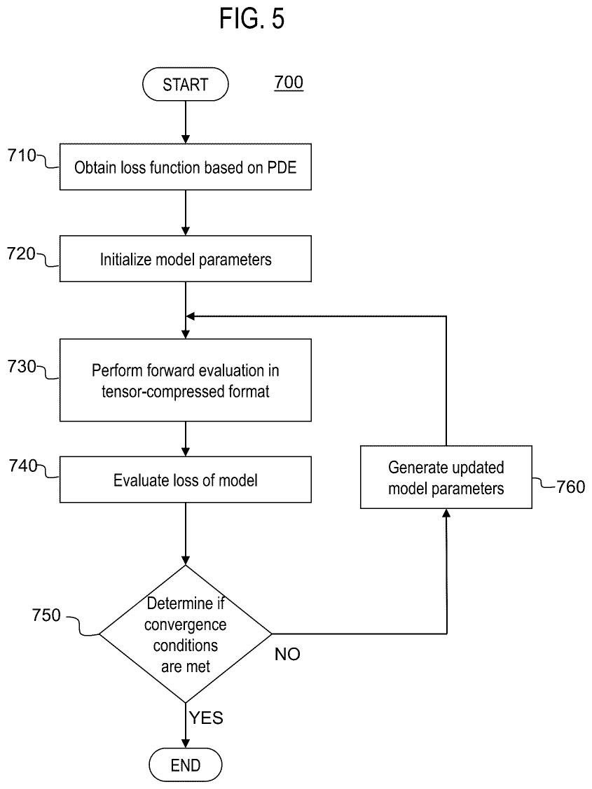

Turning to FIG. 5, an example photonic tensor core 431 will be described. The photonic tensor core 431 is one implementation example of the photonic tensor cores 231 of FIG. 2. In this example, the photonic tensor core 431 uses the mem-MRR-crossbar architecture in which multiple mem-MRR elements 236 are arranged in a mem-MRR crossbar 235. Each mem-MRR element 236 may be formed from microring resonator and a memristor, as shown in FIG. 4. The memristor is disposed on/adjacent the mirroring resonator forming a phase shifter which shifts the phase of passing light based on the state of the memristor. This wavelength-parallel photonic tensor core 431 exploits multiple free spectral ranges FSR₁ to FSRₖ from the memresonator crossbar array 235. The neural weights [symbol] (Φ) of this in-memory photonic computing architecture are implemented using memristive non-volatile phase shifters that require zero power. consumption to maintain a phase shift. Within these memresonators, memristors are directly integrated with the optical waveguide to establish non-volatile phase shifting. These devices are fabricated using a heterogeneous III-V on silicon photonic platform with the Ill-V layer forming one contact and the Si layer forming the other contact of a memristor, which simultaneously makes up the optical waveguide of the microring resonator. Since the waveguide is comprised of semiconductor materials, the insertion loss is less than 0.1 dB, which is substantially lower than would be with a memristor utilizing direct metal contacts. By applying a switching voltage on the memristor (e.g., a drive voltage received from DAC 120-2 or 120-3), the device switches its resistance by the creation of conductive filaments within the oxide material. This leads to an increase in the current within the device, and subsequently, the carrier density within the optical waveguide causing an enhanced plasma dispersion effect within the waveguide. These memresonators have demonstrated 24 hour retention times, 1,000 switching cycles, and multi-state operation. They only require an ultra-low switching energy of 0.15 pJ to switch states and can be programmed using sub-nanosecond wide voltage pulses as low as 4 V compatible with CMOS circuitry. Configurations of these devices including a 1T1R configuration will be included in which a MOSFET is integrated in series with the memristor to limit the current flowing through the memristor protecting it from permanent breakdown. In addition, these same devices can also be simultaneously used as hitless optical power monitors used for in-situ calibration and training of the photonic neural network. By quantitatively measuring the change in waveguide conductance, the free carriers generated from defect and surface state absorption of photons within the waveguide can be measured. The processed light signals output from the mem-MRR crossbar 235 can be output to a subsequent stage of photonic tensor core 431 or to a series of demultiplexers (labeled DeMux in FIG. 4) which may convert the signals into output electronic signals. The DeMux may comprise, in some examples, microring filters 251/255 and photodetectors 252/253, as previously described.

Although specific examples of photonic tensor cores are illustrated in FIGS. 3 and 4, any of a variety of photonic tensor cores can be utilized in PINN training similar to those described herein as appropriate to the requirements of specific applications in accordance with examples of the disclosure.

Systems and methods in accordance with various examples of the disclosure build upon PINNs and train PINNs into effective PDE solvers. In many examples, PINNs are trained without using back-propagation (BP) in the training process. Systems and methods in accordance with numerous examples can combine the BP-free nature of the training methods with the speed and scalability of tensor-compressed photonic chips to make the PDE solvers more efficient and accurate. Training models without using BP in a tensor-compressed format can reduce the number of training variables and gradient estimation errors, and can drastically increase the scalability of the systems. A process for training PINNs for generic PDEs in accordance with an example of the disclosure is illustrated in FIG. 5.

Process 700 obtains (710) loss functions of a PINN based on a PDE. In many examples, PINNs can be trained to be a PDE solver for various physics-related applications. Loss functions may be obtained by representing the loss functions in terms of the PDE to be solved. The obtained loss functions can include a loss function of the residual of the PDE and/or a loss function of initial or terminal conditions of the PDE. In inverse problems, the loss functions may also include a term describing the mismatch of the model with the measurement/observation data. In PDE-constraint control problems, the loss functions can also include a control objective function.

Process 700 initializes (720) the model parameters of the PINN used to approximate solutions to the PDE. In numerous examples, model parameters (e.g., Φ) can be initialized by minimizing the loss functions of the residual and/or the initial or terminal conditions. Model parameters may be compressed to a low-rank tensor-train (TT) representation for ease of training and processing.

Process 700 performs (730) forward evaluation in a tensor-compressed format. In many examples, forward evaluations of PINNs involve taking in the numerical values of spatial and time variables together with the model parameters to compute solutions for the PDE.

Process 700 evaluates (740) the loss of the PINN. In numerous examples, systems and methods can compute loss by perturbing input data (e.g., x) and model parameters (e.g., Φ) to estimate first and second-order derivatives of the differential operator of the PDE and to estimate the gradient of the PINN loss function with respect to training model parameters. In several examples, systems and methods can obtain a randomized estimation of the gradient of loss using a zeroth-order optimizer. In some examples, the estimator may be a simultaneous perturbation stochastic approximation (SPSA).

Process 700 determines (750) if convergence conditions are met. Convergence conditions in accordance with many examples can include (but are not limited to) the loss of model, the gradient of loss, the residual of the PDE, and/or compliance with the initial or terminal conditions. If the convergence conditions are met, the training may stop.

If the convergence conditions are not met, process 700 generates (760) updated model parameters. In many examples, updated model parameters are generated based on the estimated gradient of loss using a BP-free method. Updated model parameters can be used to perform additional iterations of training such that the PINN can effectively solve PDEs.

While specific processes for training PINNs for physics-related applications are described above, any of a variety of processes can be utilized to training PINNs as appropriate to the requirements of specific applications. In certain examples, steps may be executed or performed in any order or sequence not limited to the order and sequence shown and described. In a number of examples, some of the above steps may be executed or performed substantially simultaneously where appropriate or in parallel to reduce latency and processing times. In some examples, one or more of the above steps may be omitted.

Although specific methods of training PINNs for physics-related applications are discussed above, many different training methods can be implemented in accordance with many different examples of the disclosure. It is therefore to be understood that the present disclosure may be practiced in ways other than specifically described, without departing from the scope and spirit of the present disclosure. Thus, examples of the present disclosure should be considered in all respects as illustrative and not restrictive. Accordingly, the scope of the disclosure should be determined not by the examples illustrated, but by the appended claims and their equivalents.

In the description above, various types of electronic circuitry are described. As used herein, “electronic” is intended to be understood broadly to include all types of circuitry utilizing electricity, including digital and analog circuitry, direct current (DC) and alternating current (AC) circuitry, and circuitry for converting electricity into another form of energy and circuitry for using electricity to perform other regions. In other words, as used herein there is no distinction between “electronic” circuitry and “electrical” circuitry.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a”, “an”, and “the” are intended to include the plural forms as well, unless the context indicates otherwise. Moreover, the terms “comprises”, “comprising”, “includes”, and the like specify the presence of stated features, steps, operations, elements, and/or components but do not preclude the presence or addition of one or more other features, steps, operations, elements, components, and/or groups. Components described as connected may be electronically, optically, or mechanically directly connected, or they may be indirectly connected via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that functions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}”

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within ±1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the disclosure disclosed herein. It is intended that the specification and examples be considered as exemplary only, with the following claims being entitled to their fullest breadth, including equivalents, under the applicable law.

What is claimed is:

1. A digital control system for back-propagation free training of a tensor-compressed optical neural network (TONN) of a TONN inference accelerator, the system comprising:
a model input generator configured to, in a given iteration of an iterative training process, generate encoded input data and encoded parameters of the TONN and input the encoded input data and encoded parameters to the TONN inference accelerator;
a loss evaluator configured to, in the given iteration:
receive an output of the TONN inference accelerator in response to forward evaluation of the TONN inference accelerator; and
evaluate the loss of the TONN based on the received output; and
a zeroth-order optimizer configured to, in the given iteration, estimate a gradient of the evaluated loss,
wherein the model input generator is configured to, in a next iteration of the iterative training process, update the encoded parameters based on the estimated gradient of the evaluated loss as estimated in the given iteration.

2. The digital control system of claim 1, wherein the model input generator comprises:
a perturbation generator configured to generate a set of input data and a set of parameters;
a data encoder configured to encode the set of input data to produce the encoded input data; and
an encoder configured to encode the set of parameters to produce the encoded parameters in a low rank tensor-train format.

3. The digital control system of claim 1, wherein the digital control system is configured to cease the iterative training process in response to a set of convergence conditions being satisfied.

4. The digital control system of claim 1, wherein the TONN comprises an optical physics informed neural network (PINN) and the digital control system is configured to train the optical PINN as a partial differential equation (PDE) solver.

5. The digital control system of claim 4, wherein the loss evaluator is configured to determine a set of loss functions based on the PDE for evaluating the loss.

6. The digital control system of claim 5, wherein the set of loss functions comprises a loss function of a residual of the PDE and a loss function of an initial condition of the PDE.

7. The digital control system of claim 5, wherein the model input generator is configured to initialize the encoded parameters by minimizing the set of loss functions.

8. The digital control system of claim 5, wherein the loss evaluator is configured to determine the set of loss functions based on a first-order derivative and a second-order derivative of the differential operator of the PDE.

9. The digital control system of claim 1, wherein the zeroth-order optimizer is configured to estimate the gradient of the evaluated loss by obtaining a randomized estimation of the gradient of loss.

10. The digital control system of claim 9, wherein the zeroth-order optimizer comprises a simultaneous perturbation stochastic approximation (SPSA) estimator.

11. The digital control system of claim 9, wherein the encoded parameters are updated based on either the estimated gradient of the loss or the sign of the estimated gradient of loss.

12. An optical neural network (ONN) training accelerator system comprising:
the digital control system of claim 1, and
the TONN inference accelerator communicably connected to the digital control system, wherein the TONN inference accelerator comprises a plurality of wavelength-parallel photonic tensor cores cascaded in the space domain.

13. The ONN training accelerator system of claim 12, wherein the photonic tensor cores have a Mach-Zehnder interferometer (MZI) array architecture and the encoded parameters control programable phases of MZI elements in the photonic tensor cores.

14. The ONN training accelerator system of claim 12, wherein photonic tensor cores have non-volatile memristive microring resonator (mem-MRR) crossbar array architecture and the encoded parameters control states of memristors of mem-MRR elements in the photonic tensor cores.

15. A method for training an optical physics informed neural network (PINN) as a partial differential equation (PDE) solver, the method comprising iteratively:
generating a set of tensor-compressed model parameters;
performing forward evaluation of the optical PINN by approximating solutions to the PDE using the PINN based on the set of model parameters;
evaluating the loss of the PINN using a set of loss functions based on the approximated solution; and
determining whether a set of convergence conditions are met based on the evaluated loss and, in response to the set of convergence conditions not being met, beginning a next iteration in which the generating the set of model parameters comprises updating the model parameters based on the loss as evaluated in the previous iteration.

16. The method of claim 15, wherein the set of loss functions comprises a loss function of a residual of the PDE and a loss function of an initial condition of the PDE.

17. The method of claim 2, wherein, in an initial iteration, the generating of the model parameters comprises minimizing the set of loss functions.

18. The method of claim 2, wherein, in response to the set of convergence conditions being met, the training is stopped.

19. The method of claim 2, further comprising obtaining a randomized estimation of the gradient of the loss, wherein the updating the model parameters based on the loss comprises updating the model parameters based on the estimated gradient of the loss.

20. The method of claim 7, wherein obtaining a randomized estimation of the gradient of the loss comprises using a zeroth-order estimator.
